(19) United States
(12) Patent Application Publication
(10) Pub. No.: US 2024/0046204 A1
(43) Pub. Date: Feb. 8, 2024

(54) METHOD FOR USING REINFORCEMENT LEARNING TO OPTIMIZE ORDER FULFILLMENT

(71) Applicant: Dematic Corp., Grand Rapids, MI (US)

(72) Inventors: Matthew Haley, Raleigh, NC (US); Sunil Nakrani, Peachtree City, GA (US); Francisco Arzu, Austin, TX (US); Raja Ramnarayan, Atlanta, GA (US)

(21) Appl. No.: 18/365,589

(22) Filed: Aug. 4, 2023

Related U.S. Application Data
(60) Provisional application No. 63/395,056, filed on Aug. 4, 2022.

(51) Int. Cl. G06Q 10/087; G06N 20/00

(52) U.S. Cl. CPC G06Q 10/087; G06N 20/00

(57) ABSTRACT

An order fulfillment control system for a warehouse in accordance with the present invention includes a controller, a memory module, and a training module. The controller controls mobile autonomous devices, fixed autonomous devices, and issues picking orders to pickers. The controller controls fulfillment activities in the warehouse using hierarchically tiered algorithms, and records operational data for the fulfillment activities in the warehouse. The memory module holds the operational data. The training module retrains the algorithm using reinforcement learning. The training module performs the reinforcement learning on the operational data to retrain/update the algorithms. The training module retrains a macro algorithm according to a first set of priorities for optimal operation of the warehouse and retrains a plurality of micro algorithms according to corresponding second sets of priorities for optimal operation of a particular location and/or activity within the warehouse. The controller adaptively controls the fulfillment activities using the updated algorithms.

### CROSS REFERENCE TO RELATED APPLICATION

The present application claims priority of U.S. provisional application Ser. No. 63/393,056, filed Aug. 4, 2022, which is hereby incorporated by reference herein in its entirety.

### FIELD OF THE INVENTION

The present invention is directed to the control of order picking systems in a warehouse environment, and in particular to the use of algorithms used to aid in controlling the order picking systems.

### BACKGROUND OF THE INVENTION

The control of an order picking system with a variety of workers or agents (e.g., humanoid pickers, robotic pickers, item carrying vehicles, conveyors, and other components of the order picking system) in a warehouse is a complex task. Conventional algorithms are used to seek various objectives in an ever-increasing order fulfillment complexity characterized by scale of SKU variety, order composition ranging from single SKU to multiple SKUs, widely varying order demand in magnitude and time scales coupled with the very demanding constriction of delivery deadline. In recent times, this complexity is further compounded by recent labor shortages on one hand and the unforeseen dependence on e-commerce to support day-to-day activities. Conventional algorithms require a lot of effort to design, test, implement, optimize, program, and implement, and are usually very specific to customer requirements. Such conventional algorithms do not adjust well to changing warehouse/order fulfillment operations or conditions. Furthermore, the optimality of the algorithms for various agents can vary (e.g., the operational strategies for individual agents or workers may be different than the operational strategies for a facility as a whole).

### SUMMARY OF THE INVENTION

Embodiments of the present invention provide methods and a system for a highly flexible solution to dynamically respond to changing warehouse operations and order conditions for both individual agents or workers and for changing facility objectives.

An order fulfillment control system for a warehouse in accordance with an embodiment of the present invention includes a controller, a memory module or data storage unit, and a training module. The controller controls mobile autonomous devices and/or fixed autonomous devices, and issues picking orders to pickers. The controller adaptively controls fulfillment activities in the warehouse via the use of tiered algorithms, such as hierarchically tiered algorithms, and to record operational data corresponding to the fulfillment activities in the warehouse. The memory module holds the operational data. The training module retrains the algorithm using reinforcement learning techniques. The training module performs the reinforcement learning on the operational data to retrain and update the algorithms. Operational data may be used for offline reinforcement training, but online reinforcement training may also take place using facility simulation. The training module also retrains a macro algorithm according to a first set of priorities for optimal operation of the warehouse, and to train a plurality of micro algorithms according to corresponding second sets of priorities for optimal operation of a particular location and/or activity within the warehouse. The controller adaptively controls the fulfillment activities using the updated algorithms. Such a controller and training module may, for example, comprise one or more computers or servers, such as operating in a network, comprising hardware and software, including one or more programs, such as cooperatively interoperating programs.

A method for controlling order fulfillment in a warehouse in accordance with an embodiment of the present invention includes controlling mobile autonomous devices and/or fixed autonomous devices, and issuing picking orders to pickers. The controlling includes adaptively controlling fulfillment activities in the warehouse via the use of hierarchically tiered algorithms. The method includes recording operational data corresponding to the fulfillment activities in the warehouse. The operational data is held in a memory module. The algorithms are retrained using reinforcement learning techniques. The retraining performs the reinforcement learning on the operational data to retrain and update the algorithms. Operational data may be used for offline reinforcement training, but online reinforcement training will also take place using facility simulation. The retraining includes retraining a macro algorithm according to a first set of priorities for optimal operation of the warehouse and retraining a plurality of micro algorithms according to corresponding second sets of priorities for optimal operation of a particular location and/or activity within the warehouse. The method also includes adaptively controlling the fulfillment activities using the updated algorithms.

In an aspect of the present invention, the order fulfillment control system includes a warehouse simulator comprising one or more programs operating on one or more computers/servers, such as being executed on one or more processors, which performs an episodic warehouse simulation. The warehouse simulator produces simulated operational data based on simulated operations. A digital twin may be used and configured in any of the embodiments to perform at least one warehouse simulation, where the digital twin produces simulated operational data based on simulated operations.

In another aspect of the present invention, the order fulfillment control system also includes a generative adversarial networks (GANs) module that synthesizes additional data from the operational data. The additional data is synthesized data mimicking the operational data.

In a further aspect of the present invention, the operational data is at least one of: operational data recorded during performance of operational tasks within the warehouse; simulation data configured to simulate warehouse operations; and synthetic data configured to mimic the operational data.

In yet another aspect of the present invention, the controller is configured to adaptively control the fulfillment activities in the warehouse using both the macro algorithm and at least one of the micro algorithms, wherein the controller is operable to use the macro algorithm to select a particular warehouse priority and then select at least one micro algorithm to execute a particular order fulfillment operation within the warehouse.

In a further aspect of the present invention, the training module trains the macro algorithm separately from the micro algorithms.

These and other objects, advantages, purposes and features of the present invention will become apparent upon review of the following specification in conjunction with the drawings.

### BRIEF DESCRIPTION OF THE DRAWINGS

FIG. 1 is a block diagram of an exemplary algorithm training system for a fulfillment facility in accordance with the present invention;

FIG. 1A is a block diagram of the steps to a method for training an algorithm in the algorithm training system of FIG. 1 in accordance with the present invention;

FIG. 2A is a block diagram of an exemplary fulfillment facility in accordance with the present invention;

FIG. 2B is a block diagram of another exemplary fulfillment facility in accordance with the present invention;

FIG. 2C is a block diagram of an exemplary fulfillment facility illustrating the movement of goods in accordance with order fulfillment in an exemplary fulfillment facility in accordance with the present invention;

FIG. 3 is a block diagram of an exemplary fulfillment control system for the fulfillment system FIG. 2A in accordance with the present invention;

FIG. 3A is a block diagram of another exemplary fulfillment control system for the fulfillment system of FIG. 2A in accordance with the present invention;

FIG. 4 is a block diagram of exemplary components of a fulfillment facility environment in accordance with the present invention; and

FIG. 5 is a block diagram depicting the interactions of inventory allocation and order release as performed by an orchestrator of the exemplary fulfillment control system in accordance with the present invention.

### DESCRIPTION OF THE PREFERRED EMBODIMENTS

The present invention will now be described with reference to the accompanying figures, wherein numbered elements in the following written description correspond to like-numbered elements in the figures. Methods and systems of the present invention may provide for a highly flexible solution to dynamically respond to changing warehouse operations and order conditions for both individual agents or workers and for changing facility objectives. An exemplary warehouse management system includes an adaptable order fulfillment controller which includes machine learning functionality for training both a macro-agent (also referred to as an orchestrator) and a plurality of micro-agents. The training or algorithm tuning for the macro-agent includes a different set of priorities as compared to the training/algorithm tuning for the micro-agents. The macro-agent or orchestrator is trained to find optimal operational strategies for the warehouse facility while the micro-agents are separately trained according to their unique local tasks and operational requirements. The agent training (macro- or micro-) utilizes reinforcement learning that is performed on recorded operational data, operational data developed from warehouse simulators that produce simulation data, and the addition of synthesized data that is produced by generative adversarial networks (GANs) which synthesize additional data from the operational data. These three data sets are utilized during agent training to optimize their respective algorithms, with the macro-agent algorithm trained/tuned separately from the micro-agents algorithm(s).

Exemplary embodiments of the present invention provide for an AI-based procedure for the control of macro-agent (orchestrator) and micro-agent in a warehouse environment based on algorithm tuning and training such that the macro-agent is trained to find optimal operational strategies while the micro-agents are separately trained according to local tasks and operational requirements. Such controls and training modules of the exemplary embodiments can be implemented with a variety of hardware and software that make up one or more computer systems or servers, such as operating in a network, comprising hardware and software, including one or more programs, such as cooperatively interoperating programs. For example, an exemplary embodiment can include hardware, such as, one or more processors configured to read and execute software programs. Such programs (and any associated data) can be stored and/or retrieved from one or more storage devices. The hardware can also include power supplies, network devices, communications devices, and input/output devices, such devices for communicating with local and remote resources and/or other computer systems. Such embodiments can include one or more computer systems, and are optionally communicatively coupled to one or more additional computer systems that are local or remotely accessed. Certain computer components of the exemplary embodiments can be implemented with local resources and systems, remote or “cloud” based systems, or a combination of local and remote resources and systems. The software executed by the computer systems of the exemplary embodiments can include or access one or more algorithms for guiding or controlling the execution of computer implemented processes, e.g., within exemplary warehouse order fulfilment systems. As discussed herein, such algorithms define the order and coordination of process steps carried out by the exemplary embodiments. As also discussed herein, improvements and/or refinements to the algorithms will improve the operation of the process steps executed by the exemplary embodiments according to the updated algorithms.

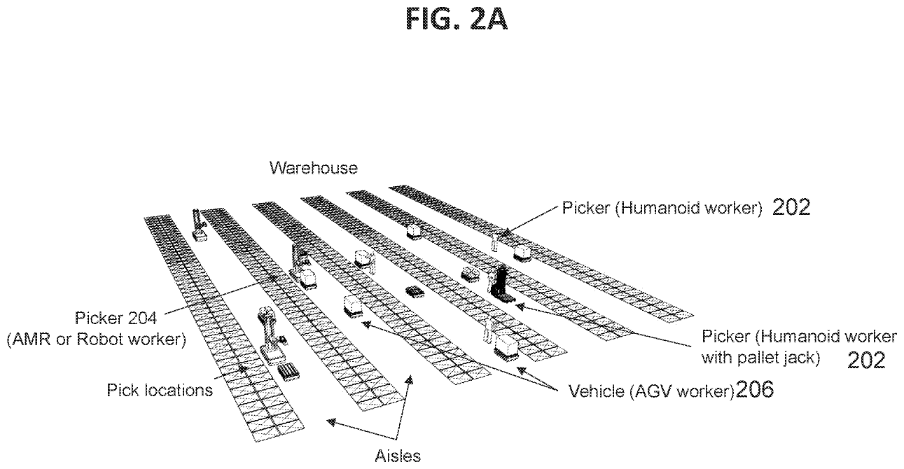

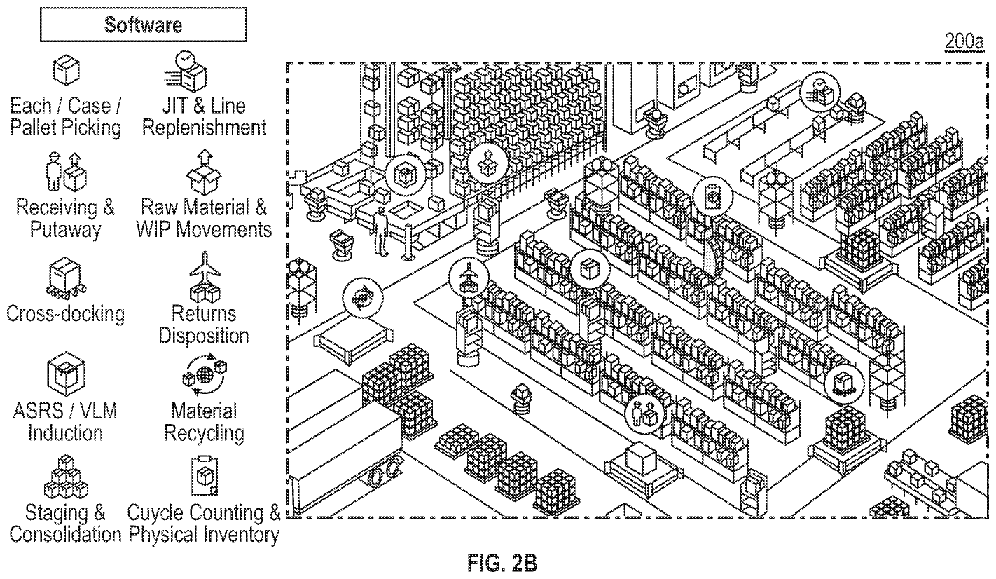

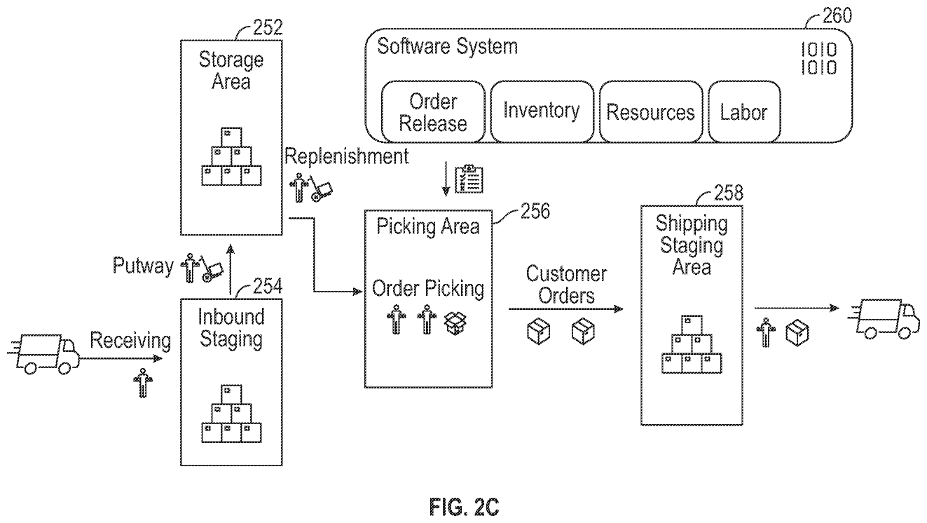

FIGS. 2A and 2B illustrate an exemplary warehouse environment 200 with a variety of different agents 202, 204, 206. Each class of agent has distinct objectives and capabilities. The agents illustrated in FIG. 2A include humanoid pickers 202, robotic pickers (also referred to as autonomous mobile robots (AMRs)) 204, and automated guided vehicles (AGVs) 206 configured to carry items picked by the humanoid pickers 202 and/or the AGVs 206. Alternatively, the AGVs may be substituted with AMRs configured for carrying the picked items. The overall logistics of the warehouse 200 would be distributed across the classes of agents. Additional agents would include fixed automation assets in the warehouse as well as the fulfillment management systems (WES, WCS, and WMS).

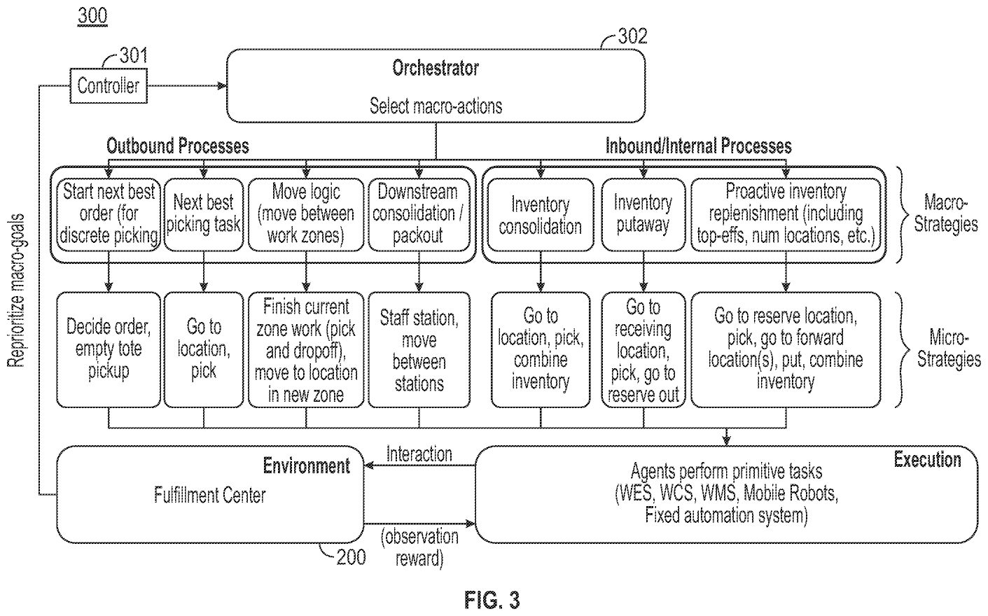

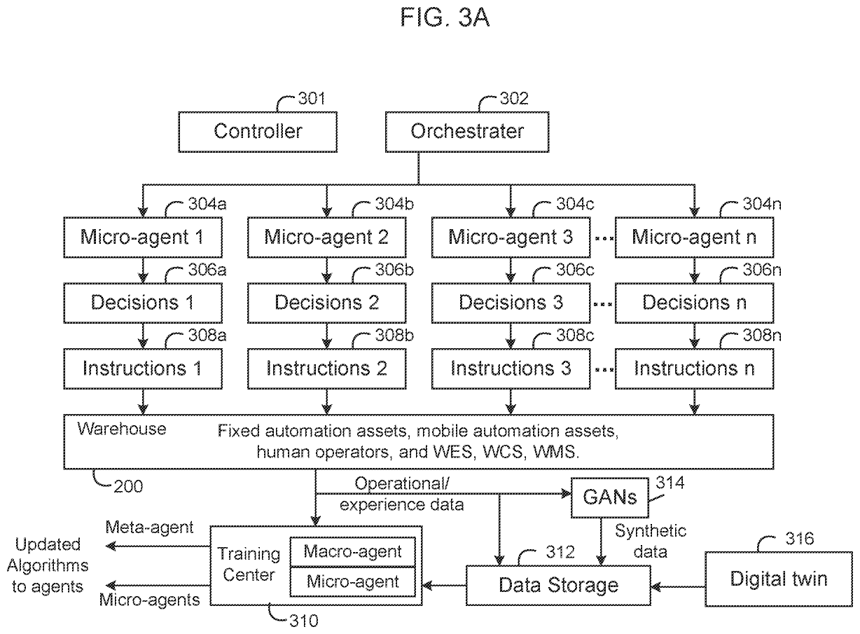

As illustrated in FIG. 3, a controller 301 of the warehouse 200 is configured to provide artificial intelligence (AI) control and optimization of agent tasks in the warehouse 200. An exemplary AI controller 301, using algorithms that are tuned via deep reinforcement learning, is configured to control different types of workers (agents) in the warehouse 200 and to optimize various objectives (global and local) of the warehouse 200. Those objectives can include, for example, time for order completion/order lead-time, traffic and congestion, quantity of workers (e.g., pickers, vehicles, and robots), energy usage, travel distance, labor cost, and pallet stability and pick pattern.

Even relatively simple workflows (algorithms) within a warehouse or facility (hereinafter “facility”) 200 require good orchestration between the different tasks performed by workers/agents and areas of the warehouse/facility to reach maximum efficiency. One of the biggest problems is that workers/agents and associated supervisors have only “local” visibility to the tasks to be performed (in their area) and not a view of the entire facility in real time. This can create problems for the optimum operation of the facility.

Modern order fulfillment (e-commerce, etc.) can rapidly change the operational conditions from one day to the next for the facility 200. E-commerce also comes with heightened consumer expectations and narrowing delivery time windows. Thus, there is a need to rapidly adjust system control to adapt to those changes. Training exposes the AI agent to variable conditions, so it is prepared to handle changing conditions in real time. Examples of such changing objectives could be different order profile (small or large orders), labor skills/performance, volume variability, product variety, delivery time constraints, etc. Conventional cost controls developed for managing volume predictions, allocating space, equipment, and labor resources, have been shown to lack robustness when applied to the new challenges fulfilling ever increasing product volume and product variety demands. Flexibility (in order fulfillment and warehouse/facility management) is being embraced to mitigate rising operational costs of complex fulfillment and to sustain profits.

### Traditional Order Fulfillment Systems

In a typical fulfillment facility 200, there are two exemplary types of tasks: inbound and outbound (see FIGS. 2C). In inbound tasks, new products enter the facility, are recorded into inventory (e.g., at an inbound staging area 254), and are stored (e.g., in a storage area 252). In the outbound tasks, orders are fulfilled (e.g., via picking areas where items from the storage area 252 are retrieved for order fulfillment) that go out to customers or stores (e.g., via a shipping staging area 258). Conventional resources needed to operate the facility 200 are limited, such as, storage capacity, labor availability, available equipment capacity and transport capacity. For the facility 200 to operate efficiently, managing these limited resources is key. Conventional software solutions generally pre-plan the tasks and resources to be used in different ways for a set period using historic statistical averages to compute the plan. However, the plan cannot be corrected in real-time if something is not going as planned.

The typical fulfillment facility will need to manage the following basic order fulfillment operations (see FIG. 2C):
1. Inbound receiving and put away (inbound staging 254): the first point of contact of new products getting into the fulfillment center. After unloading the product (e.g., from trucks), the software 260 needs to decide where to store the product (storage area 252), either in long term storage (e.g., pallet racks), or store that is more amenable for picking (e.g., simple case racking).
2. Replenishment: once orders start to be processed, there will be a need to move products from one area of the warehouse (storage area 252) to the picking areas 256. The flow needs to be controlled depending on product needs for the orders, as well as available space.
3. Order Release and Inventory allocation (the software system 260): During this process, the software 260 plans what orders will be processed, checks inventory availability, generates the proper replenishment tasks, and selects the picking areas/locations where the product will be picked.
4. Outbound order picking: Here is where the picker/worker puts together the products that need to be shipped for each order (picking area 256). There can be multiple picking areas 256, as well as multiple picking technologies used by area; from simple manual picking to more automated picking systems.
5.Outbound shipping (shipping staging area 258): The process prepares the orders to be shipped out of the facility 200. Usually, orders are consolidated, sorted, and grouped for the different carriers to load them into their trucks and start the trip to the final customer or store.

For example, in an exemplary retail facility, operations need to handle high peak ecommerce demands and high store fulfillment demands simultaneously. Conventionally, the management of both ecommerce demands and brink-and-mortar store fulfillment demands are handled within a single-focus fixed automation system. Typically, each demand is situated in a separate facility, or if the ecommerce demands are low enough, in an “omni channel” facility that serves the ecommerce channel and the brick-and-mortar channel. However, these traditional fixed automation solutions are not capable of easily adjusting to significant demand spikes or volume shifts in either channel within the omni channel facility operation.

Furthermore, even relatively simple workflows (algorithms) within a facility 200 require good orchestration between the different tasks and areas to reach maximum efficiency. One of the biggest problems is that operators and supervisors in the areas have only “local” visibility to the tasks that are performed (in their area) and do not have a view of the entire facility 200 in real-time. In other words, they are unaware of the state of operations in other areas of the facility 200. This can create problems for the optimum operation of the facility 200. This disconnect between individual local operations within the facility 200 and the operation of the entire facility 200, can include:
Shipping area 258 has limited space to store final orders before giving them to the carriers. If the picking area 256 starts to process too many orders, it will overwhelm the shipping area 258, to the point of creating gridlocks where there is no more space for the incoming picking orders. The opposite is also a problem, where the shipping area 258 is underutilized by waiting for orders to be picked (risking work starvation), or missing delivery of orders because they came too late to be loaded into the carrier truck.
Picking has a dependency from replenishment. If the product is not in the right place and at the right time for picking, the pickers (at the picking area 256) will have to wait for the product to arrive to complete the orders (picker productivity lost, shipping productivity lost).

To help in coordinating operations in the facility 200, conventional control systems, unable to constantly monitor the facility 200 make use of “waves” to coordinate each of the areas and ensure availability of storage space and resources in the downstream areas. An individual wave is a small plan of tasks and resources. Each area (e.g., 252, 254, 256, 258) of the facility 200 will finish a wave before starting the next wave. This serves as a checkpoint in a broader plan (for the facility 200 as a whole). The problem with waves is that waves do not use the resources efficiently because there will be ramp-up time in the beginning and cool-down time at the end. Full efficiency is only achieved in the middle of the wave. To help with wave transitions, staging buffers (conveyor or floor space) between the different areas are used to store inventory or order boxes coming from one area to another.

If the system controller 301 can monitor the different areas and resource in near real-time, the system controller 301 can release work incrementally as resources downstream free up, the use of waves could be eliminated. This is the main principle of “waveless” systems. However, such control systems 301 require more intelligent algorithms which have been tuned to the operational conditions of the warehouse/facility 200 (order profile, storage capacity, labor and machine performance, etc.). These algorithms will work well if the operational conditions do not change much. However, once those operational conditions begin to change, the algorithms will need to be adjusted/tuned to the new conditions. Each area of the facility 200 needs to run efficiently, but also needs to be aware of the downstream areas to not overflow or starve them. The amount of data needed to monitor, and the parameters needed to tune could be too much for humanoid interaction to tune accurately in a complex environment.

### Flexible Order Fulfillment

Modern order fulfillment (e-commerce, etc.) can rapidly change the operational conditions from one day to the next, or even from one hour to another, as well as those seasonal changes, and there needs to be a way to rapidly tune the control system 301 to adapt to those changes. Examples of the changes include different order profiles (small or large, single- or multi-unit orders), labor skills/performance, delivery time constraints, etc.). This is where artificial intelligence (AI) and machine learning techniques can be used to react and adapt the controlling algorithms quickly to changes and to keep the facility 200 running at a peak or optimal performance.

Flexible fulfilment includes the following aspects: operational flexibility and operational scalability. Operational flexibility refers to the ability of a system to change or adapt based on new conditions within an operation. Operation scalability is defined by the ease and speed in which the system can scale. Demands for e-commerce can vary weekly, monthly, and for periodic (annual) peaks. Flexibility in order fulfillment allows a facility 200 to operate adaptively depending on current needs, such as adapting for peak ecommerce periods; heavy brick-and-mortar replenishment; non-peak ecommerce; weekly, monthly, and promotional peaks; and direct-to-consumer activities. An exemplary facility 200 implementing flexible order fulfillment needs to balance fixed automation resources and mobile automation resources (see FIGS. 2A and 2B). While fixed automation systems (i.e., warehouse execution, control and management solutions (WES, WCS, and WMS, respectively)) see use in higher volume distribution centers, mobile automation systems (i.e., autonomous mobile robots (AMRs) 204, 206) are more versatile and potentially lower cost. Fixed automation assets include technologies that are bolted to the facility floor, and include unit load ASRS systems, convey and sort systems, and shuttle-based storage systems, etc. (see FIG. 2B). The fixed automation assets include an amount of WCS to manage the material flow within subsystems and are part of a larger solution. Obviously, mobile automation assets would include those technologies that are not bolted to the floor (i.e., autonomous mobile robots (AMRs)—with and without fixed-arm robots—for pallet, case, tote routing and sorting, shelf-to-person picking, and pick/put, etc.). See for example, the autonomous vehicles or AMRs 206 and the automated picker 204 of FIGS. 2A and 2B. The mobile automation assets include WCS elements to manage material flow, but also require WES and WMS elements to manage overall system congestion, system balancing, and order process to meet solution flow.

An exemplary warehouse/facility 200 includes a combination of both fixed and mobile automation, as well as an intelligent software (and its architecture) that binds fixed automation resources and mobile automation resources into a flexible fulfillment solution for the facility 200. As discussed herein, a key component of flexible fulfillment is finding and maintaining a dynamic balance between the fixed and mobile automation assets. Warehouse management (WMS) support basic functions of receiving, put-away, storing, counting and picking, packing, and shipping goods. Extended WMS capabilities are value-added capabilities that supplement core functions, such as labor management, slotting, yard management and dock scheduling. A Warehouse Control Solution (WCS) is a real-time, integrated control solution that manages the flow of items, cartons, and pallets as it travels on many types of automated equipment, such as conveyors, sorters, ASRS, pick to light, carrousels, print and apply, merges and de-casing lines. A Warehouse Execution Solution (WES) is a newer breed of solution, compared to a WMS or WCS. It is a focused version of a WMS with controls functionality. WES is encroaching on the WMS territory for tasks related to wave management, light task management, inventory management (single channel), picking, and shipping.

### Flexible Order Fulfillment System

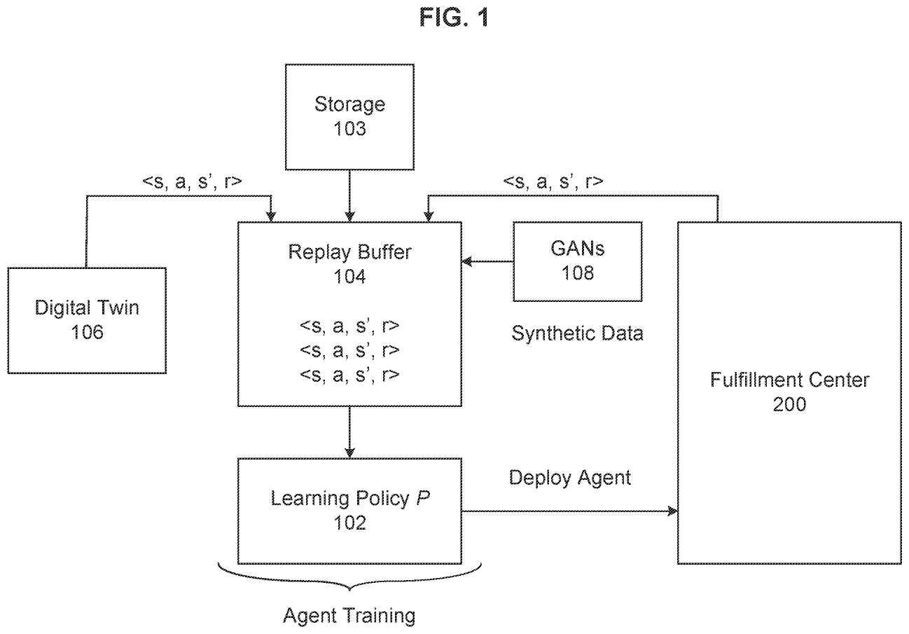

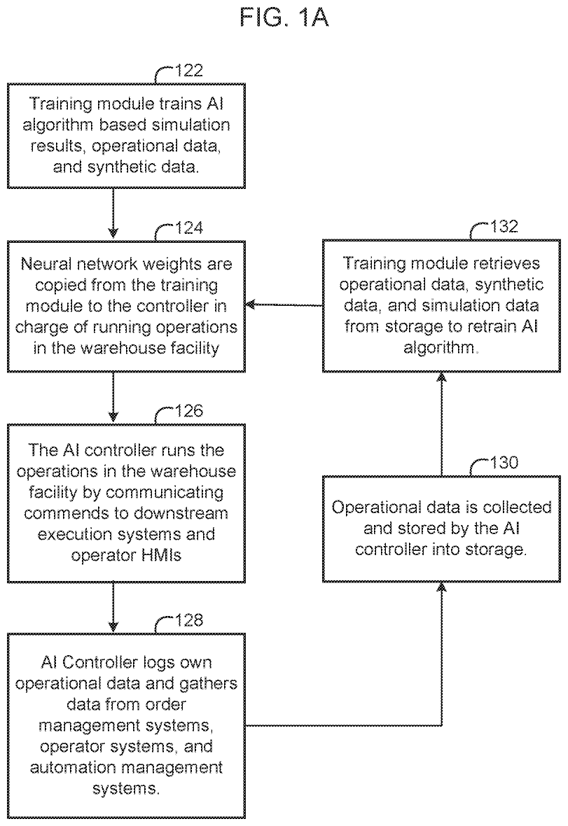

An exemplary controller 301 of a flexible order fulfillment management system 300, using reinforcement learning, is configured to control different types of agents (the macro-agent or orchestrator 302 and a plurality of micro-agents 304) in the warehouse facility 200 and to optimize various objectives of the warehouse facility 200. The controller 301 adapts to varying operating conditions and makes ongoing control and communication, and coordinates decisions amongst various systems and resources engaged in supporting the order fulfillment objective (see FIGS. 3 and 3A). A key aspect of this exemplary management system 300 is the unique ability of the agents (i.e., macro-agent (orchestrator) 302 and micro-agents 304) to learn best actions given current operating conditions and to coordinate the multiple agents 304a, 304b, 304c, 304n responsible for respective tasks to drive orchestration (via the macro-agent, the orchestrator 302) that leads to optimum order fulfillment operation over a length time horizon. Artificial intelligence (AI) and machine learning techniques can be used to retrain or tune and update the agent algorithms to react and adapt quickly to changes and keep the facility 200 running at peak performance. An exemplary algorithm training system 100 includes an application of reinforcement learning (RL) for both the macro-agent or orchestrator 302 and a plurality of micro-agents 304 to manage fulfillment center operations and an offline reinforcement learning agent training framework. As illustrated in FIG. 1, a training module 102 performs training runs in a replay buffer 104 which receives data from a variety of different sources. For example, the replay buffer 104 receives simulation data from a digital twin 106, live operational data from the fulfillment facility 200 itself, as well as synthesized operational data from the operational data using generative adversarial networks (GANs) 108. The control system includes a framework for training and subsequent deployment of agents in a commercial setting where it is infeasible to experiment in real-time for agents to learn given significant exploratory actions taken over a lengthy time horizon to arrive at an optimal policy. FIGS. 3 and 3A illustrate the steps between the orchestrator and the micro-agents, such as, the selections of processes based on macro-strategies, the selections of processes based on micro-strategies, and then the delivery of instructions to the micro-agents to perform selected tasks in the warehouse.

FIG. 1A illustrates an exemplary operational flow for an exemplary process for training and updating an algorithm provided by the controller 301 for execution by the macro-agent (orchestrator) 302 or any of the micro-agents 304. In step 122, the training module 102 trains an AI algorithm based on digital twin system simulations, recorded operational data from the warehouse facility 200, and synthetic data (produced from the operational data). The data may be supplied to the training module 102 for training in a replay buffer 104 from a memory module or data storage unit 103. In step 124, neural network weights (determined during the reinforcement learning runs) are copied from the training module 102 to the controller 301, which is in charge of running operations in the warehouse facility 200.

In step 126, the controller 301 runs the operations in the warehouse facility 200 by communicating commands to the downstream execution systems and operator HMIs (see FIG. 3A). In step 128, the controller 301 logs its own operational data and gathers data from other systems, such as, order management systems, operator systems, and automation management systems (e.g., AMR management/control systems and fixed automation management/control systems). In step 130, the operational data is collected and stored by the controller 301 into a memory module or storage 103. In step 132, the training module 102 retrieves the operational data, the synthetic data, and the simulation data from data storage 103 and retrains the AI algorithm. The operational flow then continues back to step 124, wherein the updated neural network weights (updated during further reinforcement learning runs in the training module 102) are copied again from the training module 102 to the controller 301.

As illustrated in FIG. 1, the exemplary machine learning solutions include a warehouse simulation or digital twin 106. An exemplary warehouse simulation is a high-performance 3D simulator that can represent arbitrary warehouses, manage order generation and allocation, as well as automated vehicle (AMR) control systems to navigate micro-agents through the simulated warehouse. Any controlled entity is denoted a “worker” or “micro-agent.” The warehouse simulations include AMRs configured to collect and deliver ordered items, as well as pickers responsible for collecting and placing items onto the AMRs. The complexity of the task performance by the warehouse control system 300 is largely given by the number of AMRs, number of pickers (automated or humanoid), and the number of item locations in the simulated warehouse. Inputs to simulations are empirically determined from “big data” analysis of an exemplary facility's historical operations data. The empirical inputs to the simulations are necessary (and not merely “compatible”) since agents are trained specific to that facility's operational data.

As discussed herein, the simulated warehouse includes two types of workers or agents configured to perform distinct tasks and with particular capabilities (e.g., AMRs configured as pickers or carriers). AMRs are sequentially assigned orders. For each order, an AMR has to collect specific items in given quantities. Once all items are collected, the AMR has to move to a specific location to deliver and complete the order. Upon completion, the AMR is assigned a new order (as long as there are still outstanding, unassigned orders remaining).

The exemplary pickers are configured to move across the same locations as the AMRs and are needed to load any needed items onto the AMRs. For a picker to load an item onto an AMR, both workers have to be located at the location of that particular item. As also discussed herein, the picker may be either a robotic picker or a humanoid picker.

The warehouse simulator is also compatible with real customer data to create simulations of real-world warehouse systems.

### Reinforcement Learning

As discussed herein, reinforcement learning (RL) is a type of artificial intelligence aiming at learning effective behavior in an interactive, sequential environment based on feedback and guided trial-and-error (such guided or intelligent trail-and-error is to be distinguished from mere blind or random trail-and-error). In contrast to other types of machine learning, RL usually has no access to any previously generated datasets and iteratively learns from collected experience in the environment (e.g., the operational data, the simulation data, and the synthesized data).

At each point in time, a learning agent is provided a description of the current state of the environment. The agent takes an action within this environment, and after this interaction, observes a new state of the environment. The agent receives a positive reward to promote desired behaviors, or a negative reward to deter undesired behaviors. This selection of an action, and an evaluation of the result is repeated for a plurality of possible decisions for a particular decision point.

The learning paradigm of RL has been found to be very effective in interactive control tasks. The agent is defined as the decision-making system, which maps the environment state to a set of actions for each agent (robotic and humanoid pickers and autonomous vehicles (AMRs)). The agent would be informed about the location of various items, other agents and possibly orders of the other agents. Based on such information, the agent selects an action and subsequently receives the newly reached state of the environment as well as a positive or negative numerical reward feedback. Agents are given a positive reward for good actions (such as completing an order or picking a single item) and a negative reward for bad actions (e.g., waiting too long). Such agents receive rewards according to the cumulative effect of their actions over time, as opposed to the reward for a single good or bad action.

In the exemplary warehouse system 200, there are often dozens of workers (AMRs and pickers) moving through the environment to collect items and deliver orders. In this case, solutions are needed which enable effective learning of coordination strategies across all workers. Collectively learning such a strategy quickly becomes infeasible as the overall joint-action space grows exponentially with the number of workers. In order to learn strategies for sufficiently large problems, it is necessary to decompose the decision space for independent workers. However, such distribution of learning requires these independent entities to learn to coordinate their strategies for effective cooperation. Multi-agent reinforcement learning (MARL) is designed to tackle these challenges and enable multiple independent agents to learn cooperating strategies effectively. In exemplary MARL approaches, each worker is represented by an individually learning agent.

Thus, an objective of the exemplary training system is to train a reinforcement learning algorithm to determine the strategy for allocating AMR and picker movements to optimize the order throughput for a specific time frame. Allocating AMR and picker movements: the algorithm is configured to decide where each AMR and picker should go next, at every point a decision can be made for their next location. Optimize order throughput is defined as minimizing time to compete all orders.

### Multi-Agent Reinforcement Learning for Macro-Agents and Micro-Agents

The exemplary controller 301 of a fulfillment facility 200 makes use of a multi-agent reinforcement learning (MARL) system to address problems in the fulfillment facility 200 which are primarily characterized by robotics, distributed control, resource management, and collaborative decision support, etc. The complexity of many tasks arising in such a setting makes them challenging to solve with software control learned from what has happened in the past (historical data). Application of MARL to the order fulfillment problem leverages the key idea that agents must discover a solution on their own by learning. Autonomous mobile robots (AMRs) 304 and fixed automation (automated trailer loading/unloading, multi-shuttle storage, conveyor, sorting, person-to-goods and goods-to-person, etc.), along with the requisite software (warehouse management system, warehouse control system, warehouse execution system) as sub-systems (micro-agents 304) within the exemplary order fulfillment facility 200. These sub-systems or micro-agents are optimized, orchestrated (by the macro-agent or orchestrator 302) and integrated into a control system 300.

As discussed herein, and with reference to FIGS. 2A, 2B, and 2C, throughout a day of warehouse operations at an exemplary facility 200, a multitude of tasks are assigned and executed by the various subsystems (micro-agents) (i.e., individual AMRs and fixed automation devices, etc.) and labor resources. These tasks range from the small scale, such as point-to-point movement instructions, to the large scale, such as labor commitment to various functional areas of the facility, or other operational objectives that effect the entire facility. At the present conventional state of technology, most of these decisions are made either manually by the worker/agent responsible for executing a given task or by management with some imperfect overview of the facility's operational state. At best, the present conventional state of technology allows for a locally applied algorithm that optimizes operations within some simplified scope (e.g., for a particular or select group of micro-agents 304). In an exemplary embodiment, a control system 300 for the facility 200 views each of these decision points as “agents” 304 that can execute a learned policy for selecting an “action” from within the space of possible decisions 306 encountered at that decision point 304. A decision space (for a particular decision point of a particular agent) is a list or set of possible actions that may be selected by that agent at hat decision point. As illustrated in FIG. 3A, the selected decisions 306 are then forwarded as instructions (e.g., executable instructions) to the corresponding fixed automation assets, mobile automation assets, humanoid operations, and/or WES, WCS, and WMS operating within a warehouse 200.

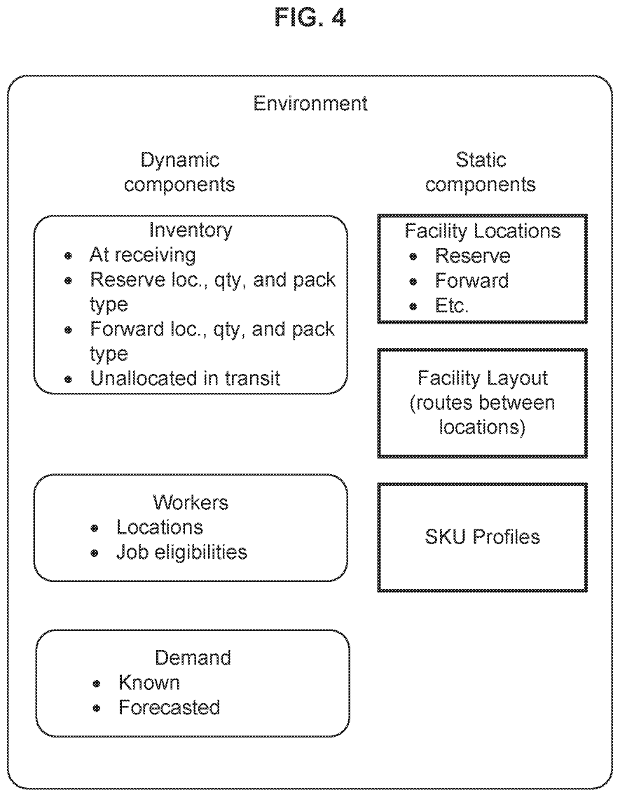

The multi-agent perspective of the exemplary order fulfillment facility 200 includes a number of agents (also considered “micro-agents” 304) representing decision points and attendant decision spaces specific to each software subsystem, collection of robots, fixed automation systems, resource/decision management systems, etc. Deep reinforcement learning via multi-agent training allows for a collaborative learning approach among such agents to take advantage of cooperative strategies that improve warehousing/facility key performance indicators (KPIs) (throughput, cycle time, labor utilization, etc.). These agents learn by interacting with the dynamic environment—in this case a fulfillment center/facility 200—whose present state is determined by previously taken actions and exogenous factors (see FIG. 4). At each time step, the agent perceives the state of the environment and takes an action, causing the environment to transit into a new state with some obtained reward. This reward signal evaluates the quality of each transition and is used by the agent to maximize the cumulative reward throughout the course of interaction. The mathematical paradigm describing this maximization of rewards over time is called a Markov decision processes (MDP).

Within restricted domains of warehouse/facility operation, micro-agents 304 may cooperate to jointly maximize rewards for a specific subsystem in an extension of MDP called a Markov game. While micro-agents 304 focus on decentralized actions to optimize specific subsystems, at a higher level of hierarchical control, a macro-agent, or “orchestrator” 302, can centrally direct cooperative orchestration across functional areas to drive optimal operating points of the global system (see FIGS. 3 and 3A). The system state of the fulfillment center/facility 200 that can be used to generate observations for reinforcement learning (RL) training at this level of control includes inventory, workers, known and forecasted order demand, and shipping/receiving related due dates. For example, circumstances such as an urgent shipping deadline approaching, inbound staging nearing capacity, or the depletion of forward inventory might prompt the orchestrator to proactively address such competing exigencies in an intelligent way in order to maximize the sum of KPI-derived rewards defined according to the relevant business considerations. Because the orchestrator 302 operates at a different level of hierarchy than the subprocesses it delegates to (i.e., the micro-agents 304), it can be trained to learn independently of those subprocesses (within a separate algorithm training run in the training module 102), thus decomposing the problem into a more tractable set of subproblems (see FIGS. 1, 3, and 3A). It could, for instance, be trained by imitation learning given historical data of manual warehouse operations. Or at a more advanced stage of deployment, it could learn via exploration based RL techniques to learn more optimal strategies than humanoid experts would be capable of manually directing.

In conventional warehousing facilities, warehousing functional areas are often optimized independently and operate in parallel under the assumption that optimal behavior among individual functions collectively constitute optimal behavior at the macro level. However, when functional areas are coupled due to the sharing of some limited resource pool, such as, labor or inventory, they are better viewed as interacting subunits of the comprehensive system whose individual activities must be coordinated to achieve the best global result. By contrast to conventional approaches, the exemplary warehousing facility 200 utilizes a control system 300 that makes use of a hierarchical decomposition of the main warehousing functions as shown in FIG. 3. Consider typical warehouse/facility functions, divided into outbound and inbound/internal. Functions appearing in dark blue boxes may be performed by any worker (humanoid and/or automated) in the most generic case. Thus, these functions can be seen as competing macro-actions in a hierarchical setting that are mutually exclusive when assigning tasks to individual labor units. In a fully interleaved functional workflow setting, workers (micro-agents 304) should be able to switch between any of these workflows according to what will best optimize the overall system. A similar hierarchical decomposition applies to order release and inventory allocation, which are coupled by inventory constraints.

A convenient way of framing this problem in a computationally tractable way is to view each functional task, or “micro-action” as independently learnable within the paradigm of reinforcement learning (RL), while “macro-actions” performed by a macro-agent or orchestrator 302, and deciding which functional task to pursue next, falls under a different hierarchy of learning which can be trained using similar or different methods to those used to train the micro-agents 304. This is in contrast to a flat, non-hierarchical framework, where agents participate in cooperative multi-agent RL (MARL) with a much larger action space. A hierarchical decomposition approach can be successful while requiring much lower computational resources than the flattened, non-hierarchical framework.

Within each of the functional tasks of the decomposed problem, the state and action spaces should be small enough to be tractable as a separate MARL problem, for which several approaches are possible. For example, distributed RL, such as IMPALA and SEED, and shared experience actor critic (SEAC) can solve large scale problems with many interacting agents. For improved scalability, several of the functional tasks may be combined as another hierarchical multi-agent problem, as in “cooperative HRL,” which further decomposes the problem's action space into options and primitives, such as going to locations, picking, and putting.

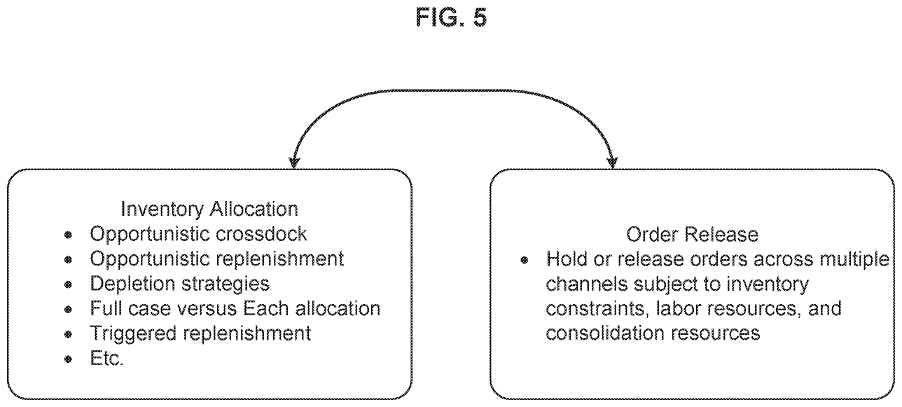

Another example of expanding the scope of decision making to encompass multiple functional domains in the warehouse/facility 200 is found in the relationship between order release and inventory allocation (see FIG. 5). These two logical functions are related through their mutual dependence on inventory. Order release is a function responsible for injecting backlog work into the system wherein it becomes “released” and subject to outbound processing. Order release obeys total inventory constraints in its simplest form. Inventory allocation usually follows order release, determining which particular inventory to allocate to various orders (if there is a choice). The allocation decision is impactful to the overall performance of the operation as it must consider which physical areas of the warehouse/facility 200 and which subsystems 304 to release work into. It may be the case that inventory for a particular SKU is available in various manually picked and also in automated picking subsystems, prompting a decision to be made as to how allocations can be best spread across these options. Other relevant considerations are the packing type of inventory to be selected from available options, such as each pick, full case, and pallet.

When these separate logical functions are treated as micro-agents 304 communicatively interacting within a dynamic environment (the warehouse facility 200), new optimization opportunities arise. For example, inventory allocation may determine that a currently released order could be fulfilled by full case inventory, but that it may be beneficial to delay allocation until sufficient demand is accrued to fully consume the full case. If this holding action is communicated to order release, it could prompt expedited release of more work requiring the SKU of the held case. While it may be difficult to develop manual heuristics to determine how long to wait, and how fully consumed a case should be before it should be allocated based on the current state of work in the pipeline and current storage space utilization, these factors can easily be accommodated within an RL framework. These separate logical functions can be trained in concert to develop collaborative strategies that would not be easily possible without the use of learning-based algorithms.

### Main Benefits of Multi-Agent Reinforcement Learning Methods

The multi-agent reinforcement learning/hierarchical reinforcement learning (MARL/HRL) approach described above promises new heights of flexibility in fulfillment compared to current/conventional methods. Such an approach will:
*Dynamically adjust workflows to current conditions.
*Optimize the facility holistically as opposed to compartmentally.
*Adapt to variable conditions in order volume and composition.
*Improve proactivity of decision making.
*Remove the micro-level decision making burden from operators.
*Deploy in an agile manner due to automatized optimization based on learned strategies.

### Reinforcement Learning (RL)-Agent Training Framework

Some obstacles to the commercial application of RL in real-world scenarios are the related problems of sample efficiency and exploration within reasonable timeframes and performance guarantees. Model-free RL approaches, while extremely powerful at honing in on optimal strategies with well-considered exploration strategies and sufficient data of state space exploration, typically require a voluminous amount of such data for success. It is usually not feasible, especially in a commercial setting, to experiment in real-time using fulfillment center/facility assets due to the adverse effects of extensive exploratory actions taken over long periods of time. To solve this problem, the exemplary control system 300 combines the data generation strengths of simulation with real world corrective data (i.e., production data collected during actual operations in the warehouse facility 200) for robust learning. As discussed herein, additional synthetic data is also produced by GANs trained on the production data.

The use of high-fidelity facility emulation or simulation tools—sometimes referred to as “digital twin” technology—is now commonplace when designing large-scale custom-tailored WES solutions. As these tools come to more closely mimic the environmental setup and workflows of the fulfillment centers/facilities they emulate, they become powerful tools for simulated experimentation of the sort required for a successful implementation of RL. When married with an RL training framework, simulation can be used for on-policy exploration and learning. On-policy RL methods, such as actor-critic variants, often offer superior training stability compared to off-policy methods such as DQN and other value-based methods. On the other hand, on-policy learning is sample inefficient since only data derived from the current policy can be used for policy updates. Once a policy update is performed, all previously recorded data must be discarded, and new data collected for the updated policy. Depending on the computational efficiency of the simulation being used, which in turn depends on the level of fidelity desired, it may be prohibitively computationally expensive to discard data, as is required for on-policy learning. In this case, it may be necessary to incorporate elements of off-policy training by using data stored in a replay buffer generated by old policies with an importance sampling correction applied during policy updates.

Another obstacle to the application of reinforcement learning methodologies in real-world problems is the simulation-to-reality gap problem, where subtle differences between the simulated training environment and the real-world environment led to suboptimal performance. To help solve this problem, the exemplary control system utilizes batch RL methods to incorporate data collected from real world operations to help close the simulation-to-reality gap. In addition to real-world operation data, as discussed herein, the exemplary control system 300 may also utilize Generative Adversarial Networks (GANs) techniques to synthesize data to provide augmentation to simulated and real data.

Accordingly, the exemplary control system 300 provides an adaptive, hierarchically sensitive control of micro-actions and macro-actions. The micro-actions are performed by micro-agents 304, which are guided by algorithms that are independently learnable within the exemplary reinforcement learning methods. The macro-actions are performed by the orchestrator 302, which decides which functional task to perform next, and whose training falls under a different hierarchy of algorithm training. The training of the macro-agent 302 may be performed using similar or different methods as those used to train the algorithms controlling the micro-agents 304.

Changes and modifications in the specifically described embodiments can be carried out without departing from the principles of the present invention which is intended to be limited only by the scope of the appended claims, as interpreted according to the principles of patent law including the doctrine of equivalents.

1. An order fulfillment control system for a warehouse, the order fulfillment control system comprising:
a controller configured to control mobile autonomous devices, fixed autonomous devices, and to issue picking orders to humanoid pickers, wherein the controller is configured to adaptively control fulfillment activities in the warehouse via the use of hierarchically tiered algorithms, and to record operational data corresponding to the fulfillment activities in the warehouse;
a memory module configured to hold the operational data;
a training module configured to retrain the algorithms using reinforcement learning techniques, wherein the training module is operable to perform the reinforcement learning on the operational data to retrain and update the algorithms;
wherein the training module is configured to retrain a macro algorithm according to a first set of priorities for optimal operation of the warehouse, and to train a plurality of micro algorithms according to corresponding second sets of priorities for optimal operation of a particular location and/or activity within the warehouse; and
wherein the controller is operable to adaptively control the fulfillment activities using the updated algorithms.

2. The order fulfillment control system of claim 1 further comprising a warehouse simulation configured to perform at least one warehouse simulation, wherein the warehouse simulation produces simulated operational data based on simulated operations.

3. The order fulfillment control system of claim 2 further comprising a generative adversarial networks (GANs) module configured to synthesize additional data from the operational data, wherein the additional data is synthesized data mimicking the operational data.

4. The order fulfillment control system of claim 3, wherein the operational data is at least one of:
operational data recorded during performance of operational tasks within the warehouse;
simulation data configured to simulate warehouse operations; and
synthetic data configured to mimic the operational data.

5. The order fulfillment control system of claim 1, wherein the controller is configured to adaptively control the fulfillment activities in the warehouse using both the macro algorithm and at least one of the micro algorithms, wherein the controller is operable to use the macro algorithm to select a particular warehouse priority and then select at least one micro algorithm to execute a particular order fulfillment operation within the warehouse.

6. The order fulfillment control system of claim 1, wherein the training module is configured to train the macro algorithm separately from the micro algorithms.

7. The order fulfillment control system of claim 1, wherein the training module is configured to train the macro algorithm to find updated optimal operational strategies for the warehouse, and wherein the training module is configured to train the micro algorithms to find updated optimal operational strategies for each corresponding local task and/or operational requirement.

8. A method for controlling order fulfillment in a warehouse, the method comprising:
controlling mobile autonomous devices, fixed autonomous devices, and issuing picking orders to humanoid pickers, wherein said controlling adaptively controls fulfillment activities in the warehouse via the use of hierarchically tiered algorithms;
recording operational data corresponding to the fulfillment activities in the warehouse;
holding the operational data in a memory module;
retraining the algorithms using reinforcement learning techniques, wherein said retraining performs the reinforcement learning on the operational data to retrain and update the algorithms;
wherein the retraining comprises retraining a macro algorithm according to a first set of priorities for optimal operation of the warehouse, and retraining a plurality of micro algorithms according to corresponding second sets of priorities for optimal operation of a particular location and/or activity within the warehouse; and
adaptively controlling the fulfillment activities using the updated algorithms.

9. The method of claim 8 further comprising simulating a warehouse, wherein said simulating comprises performing simulated order fulfillment activities and producing simulated operational data based on simulated operations.

10. The method of claim 9 further comprising synthesizing additional operational data from the operational data, wherein the synthesized data mimics the operational data.

11. The method of claim 10, wherein the operational data is at least one of:
operational data recorded during performance of operational tasks within the warehouse;
simulation data that simulates warehouse operations; and
synthetic data that mimics the operational data.

12. The method of claim 8, wherein said controlling comprises adaptively controlling the fulfillment activities in the warehouse using both the macro algorithm and at least one of the micro algorithms, wherein said controlling further comprises using the macro algorithm to select a particular warehouse priority and to then select at least one micro algorithm to execute a particular order fulfillment operation within the warehouse.

13. The method of claim 8, wherein said retraining comprises training the macro algorithm separately from the micro algorithms.

14. The method of claim 8, wherein said retraining comprises:
training the macro algorithm to find updated optimal operational strategies for the warehouse; and
training the micro algorithms to find updated optimal operational strategies for each corresponding local task and/or operational requirement.

15. A non-transitory computer-readable medium comprising one or more instructions which, if executed by an order picking system, cause the order picking system to at least:
control fulfillment activities using a hierarchically tiered model and to record operational data corresponding to the fulfillment activities;
executing reinforcement learning on the operational data to retrain and update the hierarchically tiered model;
retrain a macro model according to a first set of priorities and to retrain plurality of micro model according to corresponding second set of priority of at least one of a location and activity; and
control the fulfillment activities using the updated hierarchically tiered model.

16. The non-transitory computer-readable medium of claim 15, wherein, when the instruction is executed, the order picking system is configured to control fulfillment activities based on a reinforcement learning model of attributes of at least one of mobile autonomous devices, fixed autonomous devices, or picking order tasks.

17. The non-transitory computer-readable medium of claim 16, wherein, when the instruction is executed, the order picking system is further configured to:
perform at least one warehouse simulation, the said warehouse simulation produces simulated operational data based on simulated operations.

18. The non-transitory computer-readable medium of claim 17, wherein, when the instruction is executed, the order picking system is configured to synthesize additional operational data from the operational data, and wherein the synthesized data mimics the operational data.

19. The non-transitory computer-readable medium of claim 18, wherein the operational data is at least one of:
operational data recorded during performance of operational tasks within the warehouse;
simulation data that simulates warehouse operations; and
synthetic data that mimics the operational data.

20. The non-transitory computer-readable medium of claim 15, wherein, when the instruction is executed, the order picking system is configured to control the fulfillment activities in the warehouse using both the macro algorithm and at least one of the micro algorithms, wherein said controlling further comprises using the macro algorithm to select a particular warehouse priority and to then select at least one micro algorithm to execute a particular order fulfillment operation within the warehouse.

21. The non-transitory computer-readable medium of claim 15, wherein, when the instruction is executed, the order picking system is configured to retrain the macro algorithm separately from the micro algorithms.

22. The non-transitory computer-readable medium of claim 15, wherein, when the instruction is executed, the order picking system is configured to train the macro algorithm to find updated optimal operational strategies for the warehouse; and to train the micro algorithms to find updated optimal operational strategies for each corresponding local task and/or operational requirement.
